(19) United States
(12) Patent Application Publication
(10) Pub. No.: US 2007/0004519 A1
(43) Pub. Date: Jan. 4, 2007

(54) METHODS AND APPARATUS FOR INTERACTING WITH PLAYERS OF VIDEO MACHINES

(76) Inventors: Marius Swart, Ijamsville, MD (US); Sam Johnson, Suwanee, GA (US)

Correspondence Address: JOHN S. BEULICK;C/O ARMSTRONG TEASDALE, LLP, ONE METROPOLITAN SQUARE, SUITE 2600, ST LOUIS, MO, 63102-2740, US

(21) Appl. No.: 11/469,108

(22) Filed: Aug. 31, 2006

Related U.S. Application Data
(63) Continuation-in-part of application No. 10/689,407, filed on Oct. 20, 2003.
(60) Provisional application No. 60/717,384, filed on Sep. 15, 2005.

(51) Int. Cl. A63F 13/00

(52) U.S. Cl. 463/43

(57) ABSTRACT

A system for interacting with players of video gaming machines is described. The system includes a video gaming machine, a database for storing player information and player interaction rules for a plurality of players, and a server. The server is coupled to the video gaming machine and the database. The server is programmed to monitor the video gaming machine including identifying a player utilizing the video gaming machine and recording activities of the identified player on the video gaming machine. The server is also programmed to determine whether a player interaction rule is satisfied based on the identification of the player and the recorded activities of the identified player, and display an award offer on the video gaming machine for inducing the identified player to continue playing when a player interaction rule is satisfied.

### CROSS REFERENCE TO RELATED APPLICATIONS

This application is a continuation-in-part of U.S. patent application Ser. No. 10/689,407, filed on Oct. 20, 2003, which is incorporated herein by reference. This application also claims priority to and the benefit of the filing date of U.S. Provisional Application No. 60/717,384, filed on Sep. 15, 2005.

### BACKGROUND OF THE INVENTION

This invention relates generally to interacting with players of devices including video interfaces such as video machines. More particularly, and in one aspect, the invention relates to methods and apparatus for interacting with players of casino video gaming machines, such as video slot machines or video poker machines, through a Video Game Player Interface window overlay that appears on the video gaming machine display and which is presented, configured and managed by an application residing on a server connected to the casino infrastructure.

The electronic video games industry is a large and diverse industry. Highly complex, nearly real-life graphics are available on at least some electronic video games and the game controllers have more buttons than the most advanced combined remote controls for televisions. The gambling gaming industry has capitalized on the growth of the electronic games industry. The standard mechanical slot machines of yesterday have converged with the growth in the electronic video gaming industry to introduce a new line of electronic video games. Some of the more popular outgrowths of this convergence are the video poker, black jack and video slot machines.

The gambling gaming industry has also capitalized on applying the growth in networking technology. Today, the electronic gambling games are connected through a network to a main server that monitors the play of the games, the payouts awarded, and even the identity of the parties that are playing the game. In some known electronic gambling games, players utilize identification cards that include a magnetic strip, wherein the magnetic strip identification cards identify the player, and operate as a pre-paid card that maintains a value based on an initial value loaded when the card is obtained and is augmented by the success or failure of the user at the electronic game. Prior to commencing play, the card is swiped or entered into a slot on the machine and the identity of the player is extracted. In addition, the value loaded onto the card can be read and loaded into the machine. As play commences, the value can be increased or decreased based on the gambling results. All of this information can be fed into the main server and recorded into a database.

At least some known electronic gambling games also allow game operators to provide promotional complimentary information directly to the users of the game. This complimentary information, sometimes referred to as “comps”, may include for example a free meal, a free show or a free stay at a hotel. The comps may be granted to the game user based on gambling results, timing of play, and/or the game being played. This type of promotional event has proven to be a common technique used by video gaming machine operators to encourage play.

### BRIEF DESCRIPTION OF THE INVENTION

A Video Game Player Interface (VGPI) is described. In one aspect, the VGPI utilizes the capabilities of a gaming machine in conjunction with digital media players to interact with players based on predetermined parameters or strategies.

More specifically, and in one example embodiment, the VGPI is based on publicly shared Internet Protocol-based gaming machine data protocols and is implemented, in the one embodiment, using digital media devices that can broadcast text, video, HTML and other digital or analog information to attached video devices over basic network infrastructures. The VGPI, in one aspect, is a rules-based interface that allows flexible and robust interaction with players of casino video games without the use of proprietary broadcast or data collection devices.

In an example embodiment, VGPI allows casino owners to interact with players through any video based gaming machine that is connected to a gaming machine network. VGPI monitors machine and player activity, such as money wagered, money won, money lost, amount of time spent at machine, player identification number, and other information by interpreting standard game data distributed over protocols (approved by the Gaming Standards Association) used by manufacturers of gaming. VGPI will use a certain portion of the gaming machine video window to create a visual interface with the player, and will accept input from the user through panel buttons or touch-screen prompts. In addition, VGPI can also control certain aspects of gaming machine behavior, such as printing to the Ticket In/Ticket Out printer attached to certain gaming machines.

In another aspect, a system for interacting with players of video gaming machines is disclosed. The system includes at least one video gaming machine, a database for storing player information and player interaction rules for a plurality of players, and a server. The player information includes data representing historical gaming activity of each player and data describing each player. The player interaction rules define interactions between the gaming operator and each player. The server is coupled to the at least one video gaming machine and the database. The server is programmed to monitor the at least one video gaming machine including identifying a player utilizing the at least one video gaming machine and recording activities of the identified player on the at least one video gaming machine. The server also determines whether a player interaction rule is satisfied based on the identification of the player and the recorded activities of the identified player, and displays a comp, or more generally, an award offer on the at least one video gaming machine for inducing the identified player to continue playing when a player interaction rule is satisfied.

In yet another aspect, a method for interacting with players of video gaming machines is disclosed. The method uses a computer system coupled to a database and the video gaming machines. The method includes storing player information and player interaction rules for a plurality of players in the database. The player information includes data representing historical gaming activity of each player and data describing each player. The player interaction rules define interactions with each player. The method also includes monitoring the at least one video gaming machine via the computer including identifying a player utilizing the at least one video gaming machine and recording activities of the identified player on the at least one video gaming machine. The method further includes determining whether a player interaction rule is satisfied based on the identification of the player and the recorded activities of the identified player, and displaying an award offer on the at least one video gaming machine for inducing the identified player to continue playing when a player interaction rule is satisfied.

In another aspect, a computer program embodied on a computer readable medium for enabling an operator of video gaming machines to interact with players of the video gaming machines is disclosed. The computer program includes instructions, which when read and executed by a computer having a processor, cause the computer to perform the following steps: store player information and player interaction rules for a plurality of players on a database wherein the player information includes data representing historical gaming activity of each player and data describing each player and wherein the player interaction rules define interactions between the gaming operator and each player; monitor the at least one video gaming machine including identifying a player utilizing the at least one video gaming machine and recording activities of the identified player on the at least one video gaming machine; determine whether a player interaction rule is satisfied based on the identification of the player and the recorded activities of the identified player; and display an award offer on the at least one video gaming machine for inducing the identified player to continue playing when a player interaction rule is satisfied.

In yet another aspect, a computer for an operator of video gaming machines to interact with players of the video gaming machines is disclosed. The computer is coupled to at least one video gaming machine, and a database for storing player information and player interaction rules for a plurality of players. The player information includes data representing historical gaming activity of each player and data describing each player. The player interaction rules define interactions between the gaming operator and each player. The computer is programmed to monitor the at least one video gaming machine including identifying a player utilizing the at least one video gaming machine and recording activities of the identified player on the at least one video gaming machine, and determine whether a player interaction rule is satisfied based on the identification of the player and the recorded activities of the identified player The computer is also programmed to display an award offer on the at least one video gaming machine for inducing the identified player to continue playing when a player interaction rule is satisfied.

### BRIEF DESCRIPTION OF THE DRAWINGS

FIG. 1 illustrates an example architecture of a Video Game Player Interface (VGPI).

FIG. 2 illustrates an expanded version block diagram of an example embodiment of a server architecture of the VGPI.

FIG. 3a illustrates a display advertising a comp in accordance with the present invention.

FIG. 3b illustrates a display advertising a promotional event in accordance with the present invention.

FIG. 4 illustrates a relationship between a video gaming machine and the VGPI.

FIG. 5 is a flowchart illustrating exemplary processes performed by the VGPI.

FIG. 6 is an example embodiment of a screen shot illustrating a playlist.

FIG. 7 is an example embodiment of a screen shot illustrating a programming screen for a promotional event.

FIG. 8 is a flowchart summarizing operations of the promotional server and controller box.

### DETAILED DESCRIPTION OF THE INVENTION

The present invention includes a device that can be embedded within, or operate in conjunction with a video gaming machine. Throughout this description, a video gaming machine will refer to all kinds of gambling machines, such as video poker, black jack, roulette, Keno and slot machines, as well as typical arcade video machines. More specifically, the present invention operates to augment the display of a video gaming machine to provide the display of entertainment feeds, such as television, pay-per-view movies and advertisements, as well as provide for the display of information pertaining to promotional events. Another aspect of the present invention is a system to allow operators of the video gaming machines to customize the display of the video gaming machine and to program the types, durations and awards associated with promotional events. Yet another aspect of the present invention is a closed-loop system that allows for the display of promotional events on the screen of the video gaming machine, monitor the activity of the video gaming machine and record information indicating that an award for a promotional event has been earned. Additionally, the present invention allows for the display of a comp, transaction, or the like, and prompt and/or receive feedback or actions from a user of the video gaming machine that are provided in association with the comp being displayed. Yet another aspect of the present invention is to provide a technique for tracking demographic information pertaining to the play of a particular video gaming machine including, but not limited to, the identity of the player, the frequency of play by that player, the amounts betted by that player, the level of risk or characteristic of play of that player, and the reactionary speed of the player.

Advantageously, this invention allows operators of video gaming machines to maintain control over promotional comps being offered to users of the games, and the granting of the comps, as well as extract valuable information that can be used in augmenting the play of these video gaming machines to increase profitability and increase play time.

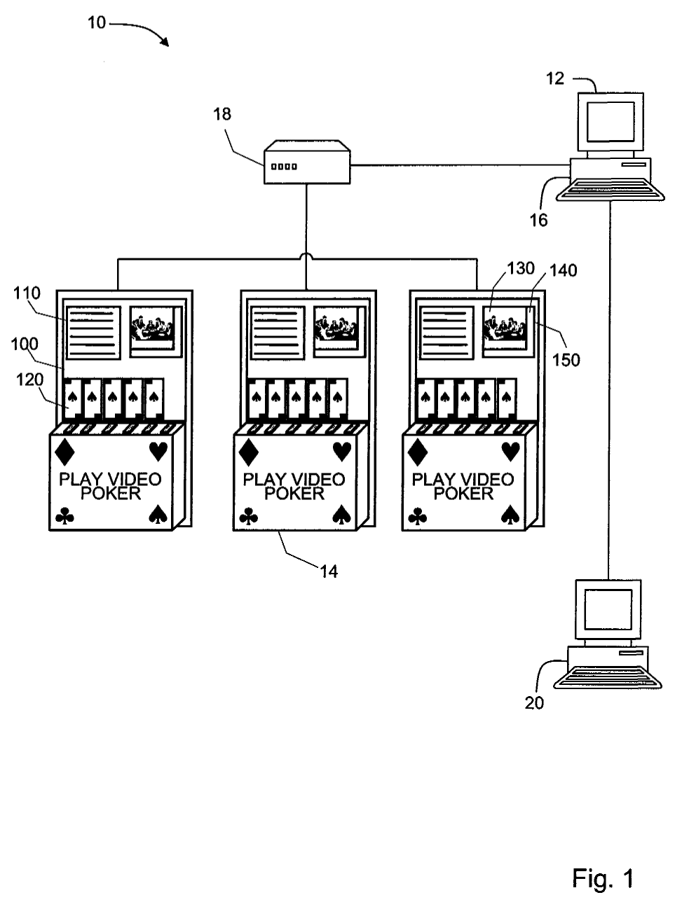

FIG. 1 illustrates one example architecture of a Video Game Player Interface (VGPI). System 10 includes a server system 12, a plurality of client sub-systems, also referred to as client systems 14, and a digital media device 18. The client systems 14 are connected to the digital media device 18 which in turn is connected to the server system 12. Computerized modeling and grouping tools, as described below in more detail, are stored in server system 12 and can be accessed by a requester at any one of computers 14. In one embodiment, client systems 14 are video gaming machines including a web browser, such that server system 12 is accessible to client systems 14 using the Internet. Client systems 14 are interconnected to the Internet through many interfaces including a network, such as a local area network (LAN) or a wide area network (WAN), dial-in-connections, cable modems and special high-speed ISDN lines. Client systems 14 could be any device capable of interconnecting to the Internet including a web-based phone, a video gaming machine, personal digital assistant (PDA), or other web-based connectable equipment. A database server 16 is connected to a database 20 containing information on a variety of matters, as described below in greater detail. In one embodiment, centralized database 20 is stored on server system 12 and can be accessed by potential users at one of client systems 14 by using a player identification card to log onto server system 12 through one of the client systems 14. In an alternative embodiment, database 20 is stored remotely from the server system 12 and may be non-centralized.

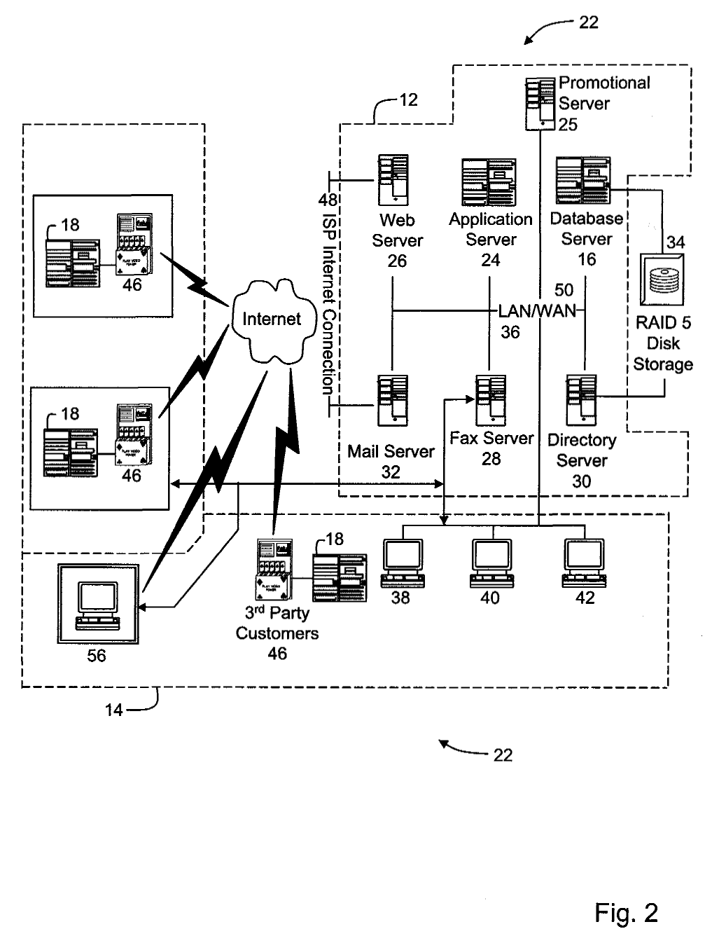

FIG. 2 is an expanded block diagram of an exemplary embodiment of a server architecture of a VGPI system 10. Components in system 22, identical to components of system 10 (shown in FIG. 1), are identified in FIG. 2 using the same reference numerals as used in FIG. 1. System 22 includes server system 12 and client systems 14. Server system 12 further includes database server 16, an application server 24, a promotional server 25, a web server 26, a fax server 28, a directory server 30, and a mail server 32. A disk storage unit 34 is coupled to database server 16 and directory server 30. Servers 16, 24, 25, 26, 28, 30, and 32 are coupled in a local area network (LAN) 36. In addition, a system administrator's workstation 38, a user workstation 40, and a supervisor's workstation 42 are coupled to LAN 36. Alternatively, workstations 38, 40, and 42 are coupled to LAN 36 using an Internet link or are connected through an Intranet.

Each workstation, 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

Server system 12 is configured to be communicatively coupled to various individuals and to third parties, e.g., clients/customers, using an ISP Internet connection 48. In the exemplary embodiment, the customers constitute players using the video gaming machines 46. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 50, local area network 36 could be used in place of WAN 50.

Referring to FIG. 1, the client system 14 includes video gaming machines 46, which may include video poker machines. However, it will be appreciated that other video gaming machines could likewise be connected to the same network. Typically, all of the operator's video gaming machines are connected to the operator's network and it is not necessary for the video gaming machines to be co-located or even be on the same premises. For the illustrated video poker machines, a display 100 is provided with a variety of content including a payout table 110 and a card stack 120.

In operation, each time a winning hand is obtained (i.e., one that matches a hand on the payout table), a message is sent from the video gaming machine 46 to the server 12 or, the information may be stored in the video gaming machine 46 or other memory storage device and the server 12 can periodically request or extract the stored information. Information is extracted from this message and stored into the server 12. The information may include, but is not limited to, the payout hand, the time and date the hand was achieved, the identity of the machine and the identity of the player. In at least some known video gaming machines, a magnetic card reader or equivalent device is included in the video gaming machine. The magnetic card reader can be used by players to insert a card that identifies the player and/or operates as a pre-loaded cash card to enable the game to be played.

Video gaming machines 46 are each in communication with digital media device 18. Digital media device 18 is capable of delivering digital media such as video, animated presentations, HTML files, flash demonstrations, text-based messages and other digital media over LANs/WANs, modems, cable, DSL and satellite networks. In some implementations, digital media device 18 will be configured to capture data transmitted by a gaming machine 46 using standard gaming machine protocols. Off-the-shelf software such as Texas Instrument's DM64x Digital Media Developer's Kit and AMD's Alchemy™ DBAul200™ allow the digital media devices 18 to be programmed to a broad degree of specifications and flexibility. This software will be configured by the VGPI system Application Server 24 of the server system 12. The Application Server 24 contains the distribution, video content and other configuration information. A casino would use the configuration ability of the VGPI system Application Server 24 to link the necessary number of digital media devices 18 to a network of gaming machines 46 to be served by the VGPI system 10. A single digital media device 18 can manage a cluster of video gaming machines 46. In turn, several clusters of gaming machines 46 can be managed by a single VGPI Application Server 24, or by a server-system 12 including a plurality of Application Servers 24.

In the exemplary embodiment, any authorized individual having a video gaming machine 46 can access the VGPI system 10. At least one of the client systems includes a manager workstation 56 located at a remote location. Workstations 56 are personal computers having a web browser. Also, video gaming machines 46 and workstations 56 are configured to communicate with server system 12. Furthermore, fax server 28 communicates with remotely located client systems, including a client system 56 using a telephone link. Fax server 28 is configured to communicate with other client systems 38, 40, and 42 as well. It should be appreciated that the video gaming machines 46 are capable of providing many different games, such as but not limited to, slots, poker, blackjack, and other casino games.

The video gaming machines 46 of the present invention include a section for the display of entertainment content 130 and/or promotional or advertising content 140. Each of the video gaming machines 46 is equipped, either internally or externally, with a controller box 150. The controller box 150 is interconnected with a main processor or controller for the video gaming machine as well as being connected to the promotional server 25 of server system 12. The controller box 150 is connected to the promotional server 25 through the network described above. The controller boxes 150 are also connected to the digital media device 18. The controller box 150 drives a portion of the display 100 by providing the entertainment content 130 and/or the advertising content 140.

The entertainment content 130 is provided to the display 100 by a feed from the digital media device 18 through the controller box 150. If the digital media device 18 includes multiple channels, the actual channel displayed can be controlled either through the controller box 150 or through the controller box 150 operating together with the promotional server 25. In some embodiments, the display 100 may be a touch sensitive screen. In these embodiments, the controller box 150 can also provide control buttons on the display 100 to allow a player to select a particular entertainment content channel, adjust the volume, hide the display, freeze the display, zoom in or out on the display, mute the audio, or the like. In other embodiments, special keys or buttons can be added to the machine, or existing keys or buttons can be redefined to facilitate this functionality.

It should be appreciated that the entertainment content may include a wide variety of content. For instance, the content may include a comp being offered to the player for complimentary meals, drinks or room upgrades. Thus, in operation, a video gaming machine incorporating the controller box aspect of the present invention inserts video or information content to be displayed on the display 100 of the video gaming machine. The video or information content prompts or invites a player to accept the comp. For instance, in one embodiment of the invention, a player may be invited to upgrade his hotel room. In this embodiment, the present invention operates to utilize at least a portion of the display 100 to indicate that the player may accept the invitation. Buttons or actuators on the video gaming machine can then be defined as response buttons and monitored for player action. Thus, as an example a pop-up window may indicate that a hotel upgrade is available and ask the player if he or she would like to upgrade his or her room. The window may define which buttons, levers or actuators on the video gaming machine may be used in response and then, monitor for any actuations. Thus, a player may hit one button to indicate he or she wishes to accept the comp and another button to refuse the comp.

The advertising content 140 is provided to the display 100 either by a feed from the digital media device 18 under the control of the controller box 150 or, from the promotional server 25 under the control of the controller box 150. For advertisement content from the entertainment feed, the operation is similar to that described for the entertainment content. However, for advertising content 140 from the promotional server 25, several innovative capabilities are provided. One such innovative capability is allowing the operator of the video gaming machines 46 to customize comps and promotional events and advertise them on the display 100 of the video gaming machine 46. Another such innovative capability is enabling the play of the video gaming machine 46 to be monitored in view of the comp or promotional event and control the granting of awards for them in a closed-loop manner.

The operator of the video gaming machines can customize the comps and promotional events available on the video gaming machines 46 through the use of the promotional server 25. The operator can directly access the promotional server 25 or can access the promotional server through the network from a remote workstation 56. In practice, the promotional server 25 executes a software program that provides a programming functionality for comps and promotional events. The actual configuration of the software program can vary between embodiments but in general, the software program includes, but is not limited to the following functionality:

(a) creation of content to display for comps and promotional events;

(b) establishing schedule of promotional events; and

(c) driving video gaming machines (Closed-loop Operation).

Creating Content for Comps and Promotional Events

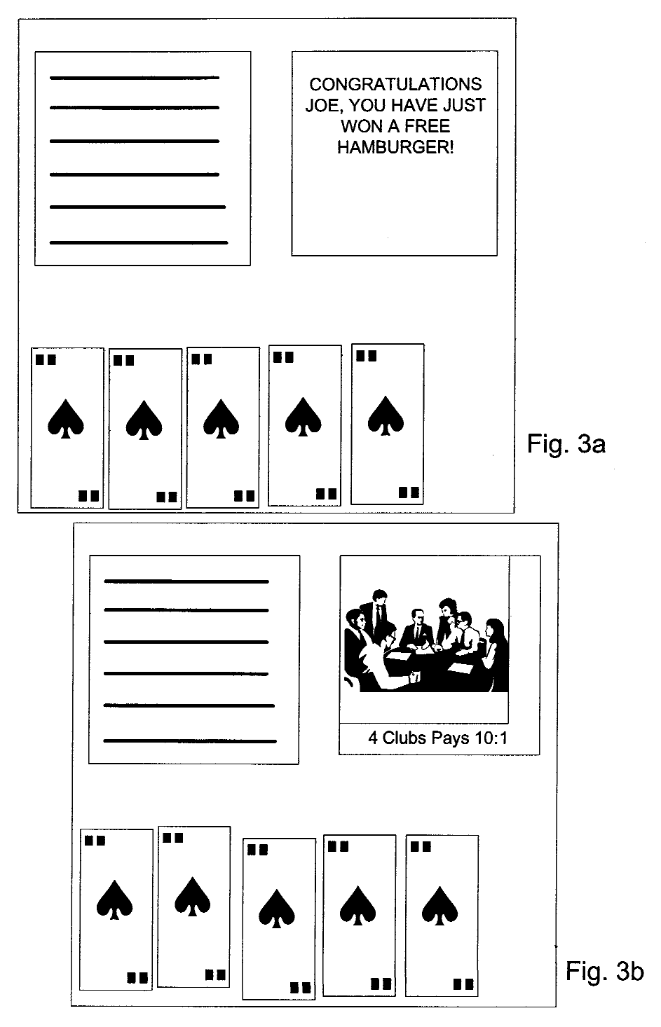

The operator creates content to display for a comp and a promotional event. The display of the content can vary from embodiment to embodiment. FIGS. 3a-3b illustrate two exemplary displays to advertise a comp and a promotional event, respectively. The content could include graphics, text, moving video, audio or a combination of any of these. The promotional server 25 allows the content to be created either utilizing the software program or to be created elsewhere and imported into the promotional server 25. The promotional server 25 accesses the database 20 containing the comp content, the promotional content and the scheduling information. The operator is able to create multiple displays for a variety of comps and promotional events and store them into the database 20 for current use or for later use. FIG. 3a shows a display format that encompasses the display area for both the entertainment content 130 and the advertising content 140. FIG. 3b shows a display format that encompasses only the display area for the advertisement content 140. Other configurations are also anticipated such as, but not limited to, flashing the entire display 100, scrolling across a portion of the display 100 and encompassing the entire display 100 for a period of time. Once the content has been created, the operator can establish rule-sets for the comps and a schedule for the promotional events.

Establish Rule-Sets

A Player Interaction Rule-Set includes rules a casino or gaming machine operator uses to interact with players using a video or electronic gambling game. Example components of a rule-set are set forth below.
gaming machine conditions
   such as a panel button that is pressed
   an event, such as a machine payout
   the status of a game (a level is reached or a certain combination of cards are encountered)
gaming session conditions (only applicable when a player registers at a machine through a player card)
   money wagered
   money won
   time spent playing
   number of times wagered
   other logical gaming session conditions derived from available gaming machine data
ad-hoc conditions
   a casino-created event, such as a competition
   specific dates or times or both
   scheduled events on specific days or other calendar criteria
   on-demand events
   events triggered by clustered gaming conditions (see below)
   events triggered by non-clustered gaming data or conditions
Gaming conditions where players are not registered through a player card (assumed and effected when a registered player ends a player session, and a new gaming session is started without a player card inserted)
Clustered gaming conditions
   when a cluster of games reach a predetermined condition similar to the gaming session conditions above
Link gaming machine reaction to gaming condition
   launch VGPI window
   clear VGPI window
   freeze rest of gaming machine screen
   release rest of gaming machine screen
   light panel button
   play a sound
   request player input in VGPI window—display relevant input prompts
   accept player input in VGPI window
   other gaming machine and player interaction

More specifically, in the exemplary embodiment, a set of rules is established for facilitating flexible and robust interaction between the players and the gaming machines 46. Each set of rules is called a Player Interaction Rule-Set and is stored in the database 20 of the server system 12. Each rule of the Player Interaction Rule-Set is comprised of several components, such as but not limited to: gaming machine conditions; gaming session conditions; ad-hoc conditions; unregistered gaming conditions; and, clustered gaming conditions. The VGPI system 10 continuously monitors the gaming machines 46 for these conditions.

The playing habits, characteristics and historical performance of players are also stored in the database 20, to the extent possible. For instance, a new player or players that are not identified by the system obviously will not have a maintained historical database. However, players that are identified to the system in one of a variety of manners can have an historical database maintained for them. The database may be created in a variety of manners including directly loading data into the database by an operator or the player, or, by the system monitoring the activity of a player, analyzing and synthesizing the data, and heuristically reviewing the data to identify trends, patterns, inclinations, etc. In addition or in lieu of, an operator or human controller may analyze the recorded and observed activity to characterize the playing habits of a particular customer.

The VGPI system 10 monitors each gaming machine 46 for certain types of gaming machine conditions. Generally, gaming machine conditions reflect machine responses to player actions. For example, during play or operation of the video gaming machine 46, the VGPI system 10 monitors, among other conditions, when a player has pressed a panel button, won a game so the machine makes a payout, or monitors when a player has reached a certain level or encounters a certain combination of cards that constitute a certain status of the game being played.

The VGPI system also monitors each gaming machine for certain types of gaming session conditions. A gaming session refers to a period of time or the games played by a player on a gaming machine from when the player first signs on to the gaming machine to when the player signs off of the gaming machine. In the example embodiment, gaming session conditions apply only to customers that register at a gaming machine 46 using a player card. Player cards are provided to customers by a hotel associated with the casino so that the hotel can identify the customers and qualify them for special casino treatment, such as free hotel room upgrades. Generally, gaming session conditions reflect players actions at a gaming machine 46. For example, during play or operation of the machine 46, the VGPI system monitors the amount of money a player has wagered. In one embodiment, the VGPI system monitors a total amount of money wagered by the player (on all games during the session or on a per game basis), the amount of money a player has won (on all games during the session or on a per game basis), the time a player has spent using a particular machine 46, and the number of times a player has made a wager. It should be appreciated that although the exemplary embodiment monitors for the session conditions discussed above, many other logical gaming session conditions and combinations of conditions may be used and derived from available gaming machine data.

Furthermore, the VGPI system 10 monitors each gaming machine 46 for certain types of ad-hoc conditions. For example, during play or operation of the gaming machines 46, the VGPI system 10 monitors a plurality of gaming machines 46 to determine winners of casino created competitions or promotional events. Additionally, the VGPI system 10 monitors the gaming machines 46 for specific times or dates or both, for scheduled events on specific days or other calendar criteria, for on demand events, and for events triggered by clustered gaming conditions or triggered by non-clustered gaming data or conditions.

Moreover, the VGPI system 10 monitors the gaming machines 46 for gaming conditions of unregistered players and clustered gaming conditions. Unregistered players are players that have ended a gaming machine session and begin a new session without registering at the machine 46 with their player card. The VGPI systems 10 monitor clustered gaming conditions when a cluster of games reach a predetermined condition similar to those discussed herein regarding the gaming session conditions.

The VGPI system 10 monitors the gaming machines 46 for conditions and upon confirming a previously defined and stored condition, prompts the gaming machine 46 to generate a predetermined reaction to the given condition. For example, the VGPI system may launch or clear a VGPI window on the gaming machine 46, freeze or release the rest of the gaming machine screen, light a panel button, play a sound, request a player input data or respond to relevant input prompts displayed on the VGPI window or accept a player's input in the VGPI window. It should be appreciated that although the exemplary embodiment discusses the conditions above, many other combinations of these conditions and different types of conditions relating to player-gaming machine interaction may also be implemented

In the example embodiment, the database 20 contains gaming machine data and is linked to the VGPI Database Server 16, the Application Server 24, and the promotional server 25 of the server system 12. Additionally, the database 20 contains the rules that determine the player interface and gaming machine activities. A subset of this data is a database that contains the data captured from each gaming machine 46 using standard gaming protocols. The database 20 can be an existing database already established by the casino to capture gaming machine data, or can be a newly created database established to store gaming machine data if the data elements to be captured exceed those being captured by the casino prior to implementing a VGPI system 10. Gaming machine data can be captured by using the communication applications such as the SAS 6.01 Toolkit provided by gaming machine manufacturers. Depending on the type of rules configured, the casino communications network capability, the number of gaming machines 46 monitored and other factors, gaming machine data may need to be captured through the digital media device 18 attached to a cluster of gaming machines 46. Once again, the commercially available software will be used to program the digital media device and to capture gaming machine data to the database 20. It is possible that the gaming machines 46 linked to the VGPI system are manufactured by different manufacturers. In this case, several communication applications may be required to capture the data to the single database 20 containing gaming machine data. It is possible in this scenario that a temporary database 20 would house the raw gaming machine data, and that the data will need to be configured into a format that satisfies the unified gaming machine data database.

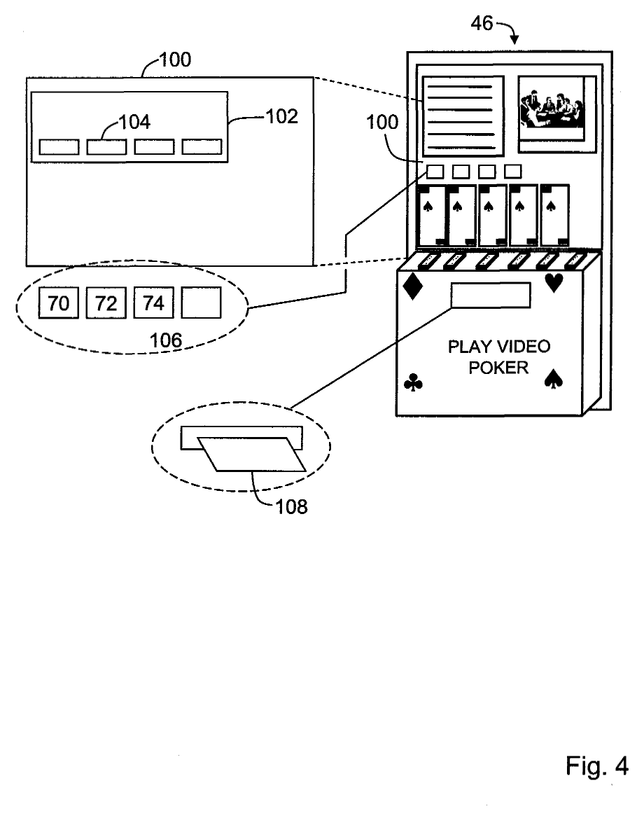

FIG. 4 shows an exemplary embodiment of a relationship between a video gaming machine 46 and the VGPI system 10. As shown, the video gaming machine 46 has touch-screen capability and includes a video display 100, a VGPI window overlay 102, VGPI prompts 104, panel buttons 106, and a ticket printer 108. The video display 100 is the main video display of the gaming machine 46, has touch screen capability and includes the payout table display 110 (shown in FIG. 1), the card stack display 120 (shown in FIG. 1) and the entertainment content display 130 (shown in FIG. 1). The VGPI window overlay 102 is controlled by the digital media device 18 and may occupy any portion or display area of the display 100. The VGPI prompts area 104 displays player prompts such as text and graphics that allow player interaction with the VGPI window overlay 102. The panel buttons 106 are part of the gaming machine 46 and may include “Cash Out” 70, “Cancel” 72 and “Place Bet” 74 buttons. It should be appreciated that any number of buttons corresponding to player machine interaction may be used. The ticket printer 108 is also part of the gaming machine 46 and is used for printing special offers and vouchers designed to induce continued playing. The video gaming machine 46 also includes a device that is able to read player tracking cards and contains a counter designed to monitor the time spent by players using a video gaming machine 46.

Each player interaction rule-set allows a different player interaction when a condition is met. The gaming machine database 20 is continuously monitored for the occurrence of a condition that will invoke a player interaction rule-set by an application that runs on the VGPI Application Server 24. The player interaction will be triggered by the VGPI window overlay 102 appearing in the field of view of the player. At this time, all other gaming machine functions are suspended (by standard protocol transactions sent to the gaming machine 46 from the VGPI Application Server 24) and the player is focused on the VGPI window overlay 102. The content displayed in the VGPI window overlay 102 is broadcasted by the VGPI Application Server 24 based on the rule-set condition encountered. A player is then requested to interact with the VGPI window overlay 102 by pressing a panel button 106 or using the VGPI prompts 104 in the VGPI window overlay 102. Should a player wish to ignore the request to interact with the VGPI window overlay 102, a panel button 106 such as “Place bet” 74 will remove the VGPI window overlay 102 and display the video display 100 of the gaming machine 46.

The VGPI Application Server 24 can serve one or many clusters of gaming machines 46, depending on the available communications infrastructure, the volume of gaming machine data captured, and the nature of content used to interface with the player. Considering the relatively low cost of application servers, it is possible that the server system 12 may include a plurality of VGPI Application Servers 24 to serve a large casino. A robust configuration can be achieved by any individual with reasonable skill in configuring networks.

The VGPI Application Server 24 will either contain the digital content to be used in the VGPI window overlay 102, or will point to the content if the content is hosted by a separate server or delivered as streaming media. The VGPI vendor in conjunction with the casino can decide on the location of the content, based on factors such as available bandwidth, hosting costs for streaming hosts such as Akamai and other factors that could influence performance or cost. The VGPI Application Server 24 also contains the database that contains configuration data for the VGPI experience for a casino, and the VGPI application software that allows the configuration of the VGPI experience. Depending on the volume of data required for VGPI setup and other normal network, application server and database considerations, several casinos, locations or gaming machine clusters could be housed on a single application server system 12. The VGPI application software will consist of the following capability per casino:
Set-up gaming machine network
   Identify one or many clusters of gaming machines
   Establish VGPI identify for machines or clusters
Associate specific gaming machines or clusters of gaming machines with established rules
Associate specific gaming machines or clusters with gaming machine data communication applications
Configure gaming machine data database(s)
   Establish data elements captured from the gaming machine
   Configure gaming machine data communication applications
Link content to display according to the rule-set configuration
Other configuration requirements

In the exemplary embodiment, the VGPI application software is the same for all casinos. Specifically, the software is able to establish gaming machine networks. As part of establishing the networks, the software identifies one or many clusters of gaming machines 46 and establishes VGPI identities for gaming machines 46 or for clusters of gaming machines 46. The VGPI application software is also able to associate specific gaming machines 46 or clusters of gaming machines 46 with established rules. Additionally, the VGPI allocation software is able to associate specific gaming machines 46 or clusters of gaming machines 46 with gaming machine data communication applications. Further, the VGPI application software is able to configure gaming machine data databases 20 which includes establishing data elements captured from the gaming machine 46 and configuring the gaming machine data communications applications. Moreover, the VGPI application software is able to link content to the gaming machine display 100 according to the rule-set configuration. It should be appreciated that the VGPI application software is not limited to the capabilities discussed herein, and may also be designed to satisfy other configuration requirements.

The VGPI system 10 can be used by casinos in many different ways to augment their interaction with players and to facilitate increasing money wagered and time spent on gaming machines 46. The VGPI system 10 will facilitate impacting the casino's ability to influence player behavior based on real-time playing conditions of the individual, the gaming machine 46, or various combinations of factors.

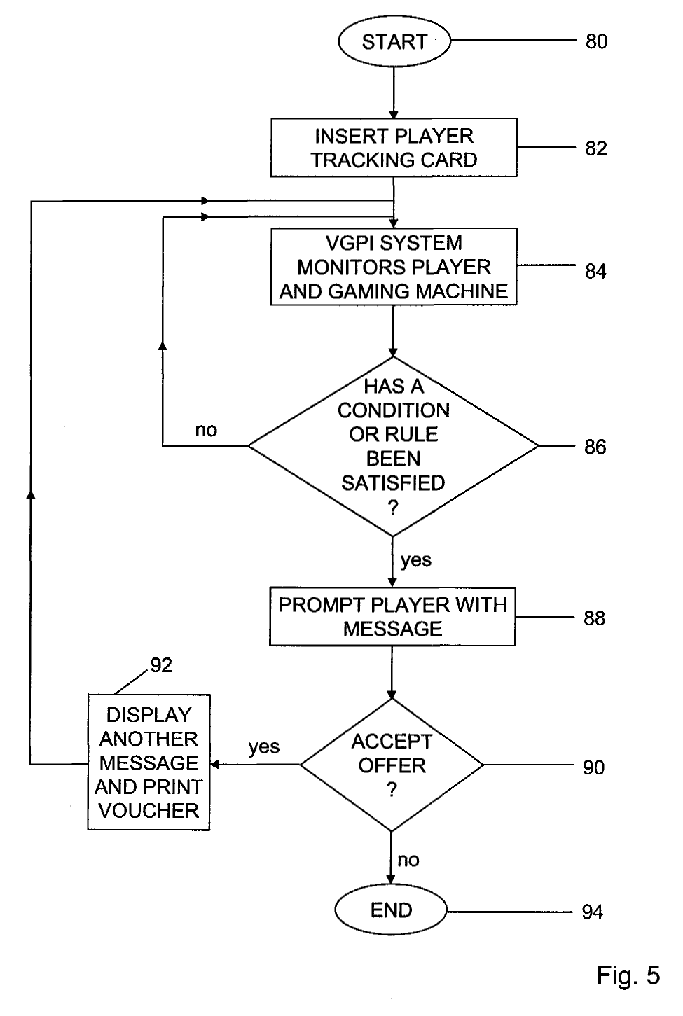

FIG. 5 is a flowchart illustrating an exemplary process performed by the VGPI system 10 whereby a player is rewarded with a free hamburger voucher after playing a video slot machine for 15 minutes. Of course, many different types of awards and scenarios are possible, and the following is just one example of how a casino may interact with a player via the VGPI system 10.

### EXAMPLE

Beginning at 80, a player approaches a video slot machine 46 and inserts a player tracking card 82 that identifies him as Joe. Joe uses the card because the more Joe plays, the more Joe qualifies for casino “comps”, such as free upgrades to hotel rooms.

Joe typically is made aware of these “comps” either through a casino host, an email, a letter or through other basic marketing events that normally occur after Joe completed his visit. Every time Joe visits a machine 46 that can read his player tracking card, Joe makes sure he uses his card to build up time played.

Joe continues to play the machine 46, and he typically spends 15 minutes or so on a machine 46 after which he likes to move to another machine 46. While Joe plays, the VGPI system 10 monitors his play 84 at the gaming machine 46 to determine whether a condition or rule has been satisfied 86. So, after 14 minutes of play during which Joe won some money and lost some money and just as Joe was ready to leave to try his luck on another machine 46, a condition or rule was satisfied, and a window appears on the screen 100 of the slot machine 46 with the following message 88: “Congratulations, Joe—you have just won a free hamburger! Press “Cash Out” to accept 90 or “Cancel” to continue playing 90”. Both the “Cash Out” 70 and “Cancel” 72 panel buttons are lit on the gaming machine and Joe decides to take the free hamburger by pressing “Cash Out”. Another message appears 92 on the slot machine screen 100 “Your voucher 92 is being printed . . . ”, and Joe looks down to see a “Free Hamburger at Food Court” voucher printed from the Ticket In/Ticket Out printer 108. Joe is amazed at the customer service, and as a hamburger would have cost him $4, Joe decides to play a few more bets as he just saved $4. And frankly, Joe was curious of what else he could win by playing a few more minutes! Should Joe have refused the offer, he would have ended playing the video gaming machine at 94.

In the foregoing example, the VGPI system 10 is used by the casino to set up rules to interact with players while they are playing. In this case, the VGPI system 10 was configured with a rule that will reward Joe with a free hamburger if he spends 14 minutes on a particular machine 46. The second Joe inserts his player card into the gaming machine, a counter starts tracking time against the particular machine 46 and time against the player number while that player card remains inserted. This counter can be read at any time by a communications program setup to read the counter. Like the counter used in this example, various aspects of gaming machine data are made available to casino owners through standard gaming data protocols that can be accessed by custom written software designed by developers with ordinary skill in the art. The VGPI system 10 is configured to read the required set of data into a gaming machine data database 20, and an application is running on the VGPI application server 24 that continually monitors all the player interaction rule-sets and compares them with the gaming session data. In this case, when the database element stored in the gaming machine data database 20 reached 14 minutes, a rule was satisfied and an event trigger was encountered. The VGPI application is configured to know exactly what to do when this trigger occurs: in this example it sends a video broadcast that is stored on the VGPI Application server 24 to the gaming machine 46 that includes a graphic that displays “Congratulations, Joe—you have just won a free hamburger!” It knew who Joe was, because it had XML code, a stored procedure or some other database instruction that connected to the marketing relational database 20 that stored the card number and Joe's name when it first encountered a new player at the machine 46. It was the same marketing database 20 that had the information that Joe normally plays 15 minutes on a slot machine 46. The casino set up a player interaction rule after 14 minutes of play, because the casino wanted to make sure Joe did not leave before they could offer him a free hamburger. As part of the VGPI Application, instructions were sent along with the graphic to allow Joe to accept or cancel the offer, and if Joe accepted, to send instructions to the standard Ticket In/Ticket out printer 108 to print a voucher. Because the VGPI Application uses standard available gaming machine protocols to send instructions to the gaming machine 46, the game result is not influenced and it is therefore possible for the VGPI vendor to interact with the machine 46 without needing to change programming to the actual game.

In other words, the VGPI application is configured to know exactly what to do when a trigger occurs: in the example it sends a video broadcast that is stored on the VGPI Application server 24 to the gaming machine 46 that includes a graphic that displays “Congratulations, Joe—you have just won a free hamburger!” Based on the historical playing information of Joe, which is stored in the database, the casino knows that Joe normally plays 15 minutes on a slot machine. The casino also knows how much money Joe normally wagers. Thus, the casino can set up a player interaction rule that after 14 minutes of play Joe will be offered a complimentary hamburger. By doing so, the casino is attempting to increase the time Joe spends at the slot machine.

Various mechanisms, techniques or algorithms can be used to determine the kinds of award, inducement and or comp. In one embodiment, the awards can simply be canned awards, drawn out randomly or in accordance with a schedule or some predetermined order. In another embodiment of the invention, the awards can be based on information obtained about the player. For instance, if the identification card used by the player to identify the player to a gaming machine is also used in local restaurants, stores, etc., this information can be extracted to identify the most enticing awards to provide the customer. For instance, if the user presents his or her identification card at a local store multiple times, an award for a coupon to that store, or a discount for a particular item in that store may be awarded. Likewise, if the customer frequents the same restaurant, a coupon to the restaurant may be awarded. However, in the example above, it may be that Joe purchases a hamburger everyday around 11:45 at the casino bar and as such, the free hamburger may be quite the enticing award.

Also, in the above-described example, the award was presented to Joe just prior to the expected threshold of time at which he typically moves to the next machine. This is a timed based algorithm that is used to determine when to display the award. However, those skilled in the art will appreciate that a variety of other algorithms could be used for determining when and how to display an award to a customer. It should also be appreciated that the timing may simply be random or may be canned or preprogrammed intervals. But, in other embodiments dynamic algorithms with intense heuristics may be applied. For instance, after monitoring a particular player over a period of time, it may be determined that the player increases the size of his or her bets shortly after hearing the bells of a big win at a gaming machine located in close proximity, or at least within ear-shot of the player. This information can be used by the system to encourage the customer to place larger bets by informing the customer of the size of jackpots just won on machines that are outside of the customer's hearing. Similarly, the system may detect that a particular customer, after obtaining a level of winnings, has a tendency to increase the frequency and size of bets, as well as the pace of play as the dinner hour approaches and then the customer disengages from play for 4-5 hours. The system can conclude from this information that in anticipation of breaking for dinner, maybe triggered by aromas in the casino, the player becomes more aggressive. Knowing this, the system could provide awards or incentives such as more frequent double down opportunities, higher betting ceilings, etc. In addition, the system may provide a particular award.

Thus, it will be appreciated that a variety of algorithms, heuristics and logical reasoning can be applied to the gathered data to control the various aspects of the present invention, including but not limited to, the types of awards, the timings of award presentations, or the like.

The combination of predefined rule-sets, the monitoring of gaming machine data and the ability to provide interaction with a gaming machine player has many potential applications other than the example described above.

This aspect of the present invention can be provided using a variety or a combination of system or components. For instance, in an alternative exemplary embodiment the invention may be embodied within a controller box 150 embedded or interfaced to the video gaming machine. In this embodiment, the controller box 150 interfaces to an external source for the comp, promotional event, offer, or the like, analyzes the same and formulates the presentation to the customer. In addition, the controller box 150 detects, receives and interprets all activities of the customer, monitors the event, activity or offer and provides or assists in all fulfillment activities. In such an embodiment, the controller box includes a display interface that can interface with the display system of the video gaming machine. Through the display interface, the controller box 150 can operate to display a comp to the customer on the display of the video gaming device, thereby inviting the customer to accept the comp. The controller box 150 also includes an interface to one or more actuation devices on the video gaming machine to receive a response from a player indicating acceptance of the invitation, request for more information, acceptance of an offer, provision of funding information or the like. The controller box 150 also includes an interface to an event monitor for obtaining status information pertaining to an event. It should be appreciated that the present invention can be incorporated into other systems, such as a promotional server, or a combination of one or more systems.

Establishing a Promotional Event Schedule

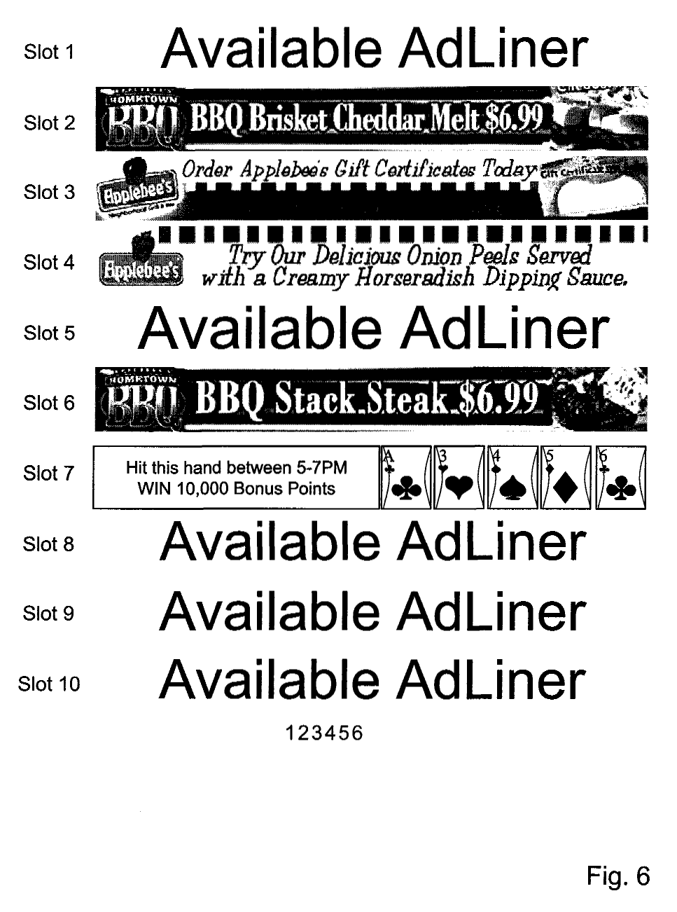

The operator establishes a schedule for the promotional events that can include, among other parameters, the date and time for the event, the duration of the event, and the display content to promote the event. In one embodiment, the schedule is presented in the form of a playlist. Each item in the playlist can be customized and scheduled. FIG. 6 is an example embodiment of a screen shot illustrating a playlist. The playlist consist of multiple slots (Slot 1-10 in this example) and can be spread out over multiple pages (page 1-6 in this example). In the illustrated embodiment, Slots 2-4 and Slot 6 hold advertising content. Slot 7 has been programmed to hold promotional content. Furthermore, the illustrated embodiment is implemented in mark-up languages and viewable through a standard browser, however, those skilled in the art will appreciate that the particular implementation language and/or technology, as well as the specific formats, look-and-feel and operations of the software program are independent of and not relevant to the particular operations of the described aspects of the present invention. Thus, although the remaining examples will be described as including particular operations that result in particular screen views, the present invention is not limited in such a manner.

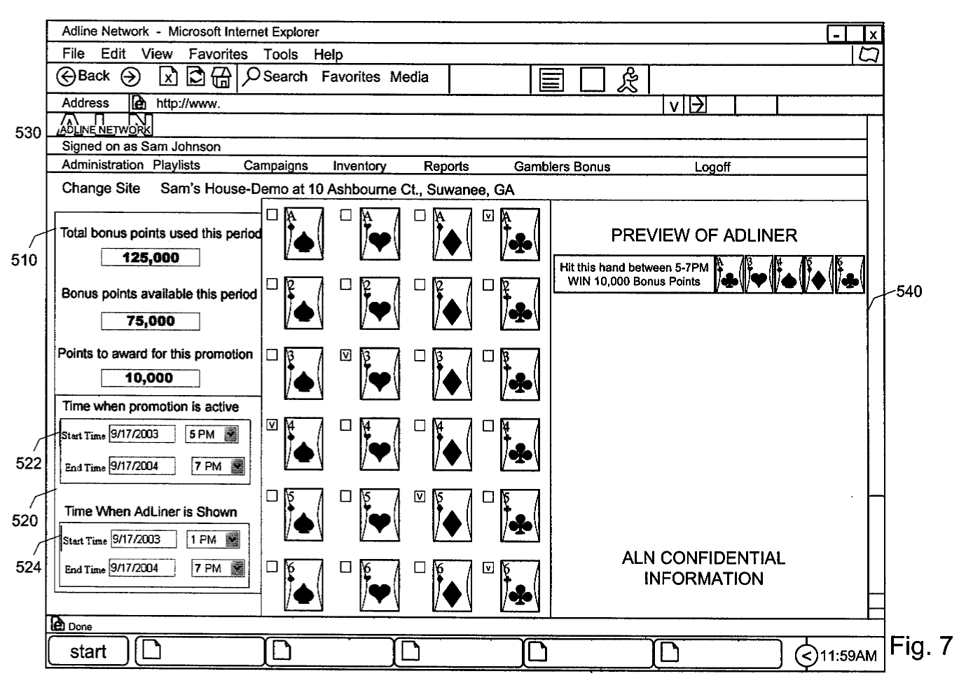

To edit or create promotional content, the user selects the applicable Slot X hyperlink. For instance, if an operator desires to create the promotional event that is currently displayed in Slot 7, the operator selects Slot 7 and the resulting display is illustrated in FIG. 7.

FIG. 7 is an example embodiment of a screen shot illustrating a programming screen for a promotional event. The programming screen includes a bonus area 510, a scheduling area 520, a promotional definition area 530 and a preview of the promotional content area 540. The bonus area 510 identifies the bonus points that have been awarded during a particular period of time. This feature allows the operator to keep track of the amount of bonus points that have been awarded. It should be appreciated that the bonus points can represent a variety of awards. For instance, in a gambling embodiment, the bonus points may translate directly into monetary units. In a gaming scenario, the bonus points may represent credits for additional play or can be redeemed for prizes. In a charitable situation, the bonus points may translate into bidding power for a silent auction. In a restaurant/bar setting, the bonus points may translate into discounts for food or beverages. It should be appreciated that additional uses could easily be identified for various scenarios. The bonus area 510 also identifies the bonus point available. This may represent the amount of bonus awards that the operator has remaining in his desired budget. For instance, for a particular period, an operator may budget bonus points and the budgeted amount will be the sum of the total bonus points awarded and the bonus points available for this period. The bonus area 510 also includes an editable field in which the operator can select the bonus points that will be awarded for a particular promotional event. In the illustrated embodiment, the operator has selected 10,000 bonus points. In one embodiment, the promotional event can be scheduled to run for a particular period of time and/or until a budgeted amount of bonus points have been awarded.

The scheduling area 520 includes two sub-areas, the promotion active time 522 and the promotion display active time 524. During the programmed promotion display active time, the promotional content identified in the promotional content area 540 will be available for display. During the programmed promotion active time the promotion will actually be in effect. In some embodiments, an additional field can be displayed and edited to allow the operator to select the duration of time that will be dedicated to the slot in which the promotional event is programmed. For example, each programmed slot may be allocated to be 15 seconds and be cycled on the display in a round-robin fashion. Thus, when actual time falls within the programmed display active time for the promotional event, the promotional content will be displayed in a periodic manner. It should be appreciated that priorities could be assigned to particular slots and that varying time frames can be allocated for various slots also.

The promotional definition area 530 allows the operator to define the particular winning criteria for the promotional event. In the illustrated embodiment, the operator has selected the following hand to constitute a win:
A [symbol] 3♥4 [symbol] 5♦6

[symbol]

The operator may also program “don't care” or “wild card” conditions also. For instance, on Valentines Day, the operator may run a promotion in which the following hands constitute a win:
Q♥ K♥ (don't care) (don't care) (don't care) or
Q♥ (wild card) (don't care) (don't care) (don't care) where a wild card is any card that is a heart.

Thus, a player that draws the Q♥ and the K♥ or any heart card in any hand during the active time for the promotion would be awarded the bonus points.

The preview of the promotional content area 540 indicates the content that will be displayed during the programmed program display active time. In some embodiments, multiple content formats can be provided and the operator can select from the various formats. In other embodiments, an operator may select multiple formats that can be cycled through or randomly selected during the programmed promotion display time. It should be appreciated that the software program can automatically generate the display content, allow an editing function so that the operator can customize the display content, or allow the operator to import display content created from another application.

Closed-loop Operation

The present invention also provides for closed-loop operation. The closed-loop operation, in general, allows for the recording of events that satisfy the winning criteria and then reporting the win to the operator in a controlled and secure or reliable manner. Advantageously, this aspect of the present invention helps to reduce or eliminate fraud in the awarding of comps and bonus points to players.

In an exemplary embodiment, the controller box 150 interfaces to the processor of the gaming machine 46 and to the promotional server 25. The controller box monitors activity information pertaining to the operation of the gaming machine. Although the gaming machines typically filter out hands that are transmitted over the network to the server 12, the gaming machines 46 still include the logic to identify the hands that are not classified as winning hands on the payout table 110. The controller box 150 interfaces with the processor to identify all hands that are dealt.

This aspect of the present invention advantageously enables the monitoring and tracking of a variety of demographic information. For instance, in a video poker game environment, the controller box 150 can monitor and track the operations of a player, such as hands dealt, cards held, cards discarded, etc. This information could be used for a variety of purposes including identifying unsophisticated players that may need to attend a help session or players that are trying to trick the machine.

The present invention also includes the ability for the player to interact with the gaming machine 46 in response to the comp. For instance, during standard play, the present invention can operate to display a comp message to the player to prompt for an action, and then provide an award based on that action. One example is to display a message directed towards a particular gaming machine 46 or a particular player. A typical message could state that the player has qualified for a free comp, such as winning a free hamburger. The comps could also be a variety of things, such as a coupon for a $2.00 steak dinner, a 10% discount at the gift shop, or a free round of golf with the purchase of a round. Depending on the particular embodiment, the players responding to the prompt may receive a printed receipt generated by the gaming machine 46, have the coupon recorded onto a magnetic strip of a card, receive a token, be requested to enter identification information into the gaming machine that can later be used to verify the win, or the machine can simply sound a bell or flash a light to get the attention of a game room attendant that can provide the coupon to the player.

In another example, during a promotion the message may state that a player can exchange points or perform tasks to view pay-per-view content. The response time for performing the task may be restricted (i.e., in the next 5 minutes or immediately) or may be conditional on other attributes such as betting amounts, playing time, or the like. In one embodiment, while the promotional message is displayed, the player can respond by touching the displayed promotion on a touch sensitive screen. A confirmation message will then appear to verify that the player wants to exchange points, or pay for the reception of the pay-per-view content. In one embodiment, the gaming machine can print out a ticket that the player can use to access the pay-per-view content. In another embodiment, the pay-per-view content may directly appear on the gaming machines screen. In this embodiment, the player may be required to meet certain playing thresholds to keep the pay-per-view content on the screen (i.e., minimum number of bets per hour, betting a minimum amount).

Another variation on promotional events that can be implemented in an embodiment of the present invention is a tiered promotion. The tiered promotion requires a player to opt-in to a promotion. In operation, a promotional message is provided to the player indicating that the player can pay an additional fee (i.e. points or money) to win a chance at 10,000 additional bonus points if they meet certain win criteria. Such a promotion could be limited on a per session basis.

In one embodiment, the promotional server 25 may download into the controller box 150 all of the information regarding the scheduling of advertisements and promotional events. In this embodiment, the controller box 150 operates to control the display and timing of the display. In addition, during the programmed promotion active time, the controller box 150 will monitor for hands that meet the winning criteria. Once a winning hand is identified, the controller box 150 will notify the promotional event server 25 and provide any necessary information such as, but not limited to, the identity of the video gaming machine 46, the identity of the player, the time and date and the particular hand that satisfies the criteria.

In another embodiment, the controller box 150 may operate more similar to a dummy terminal. In this embodiment, the promotional event sever 25 is responsible for controlling the timing and content of the display and continuously downloads the necessary information to the controller box 150. The controller box 150 then controls the actual display of the content onto the display screen 100 of the video gaming machine 46. The controller box 150 then sends information to the promotional event server 25 for every hand that is dealt and the promotional event server 25 monitors the hands to identify when winning criteria has been met.

It should be appreciated that these two embodiments are just two illustrative embodiments as to how the processing power for the closed-loop system can be allocated. Those skilled in the art will appreciate that the actual processing power attributed to the various tasks can be allocated between the controller box 150, the promotional event server 25 and the VGPI Application Server 24 in a variety of fashions and the present invention is not limited to any particular configuration. In fact, all of the functionality can be incorporated into either the controller box 150, the promotional event server 25 or the VGPI Application Server 24 and totally eliminate the need for the other devices.

Ultimately, either the promotional event server 25 or the VGPI Application Server 24 obtains the information necessary to identify the player and the award that has been earned by the player. The operator can extract this information directly from the promotional event server 25 or the VGPI Application Server 24, by accessing the appropriate server 24, 25 through the network.

Thus, it should be evident that the present invention eliminates the risk of loss associated with the current art in which the operator is dependent upon the integrity of an employee or any other party that would ordinarily be responsible for being approached by a player purporting to have qualified as a winner, who then must physically visit the particular gaming machine 46 to observe the display, and then record the information and report that information back to the operator.

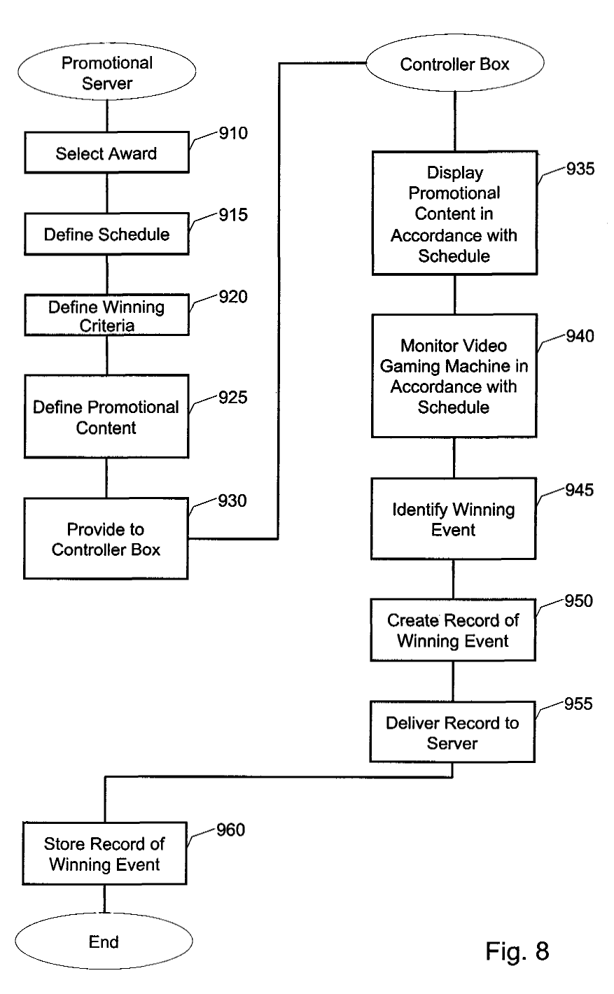

FIG. 8 is a flow diagram summarizing an exemplary embodiment of the operations of the promotional server and the controller box. At step 910, the operator using the promotional server identifies the award to be associated with a new promotional event. At step 915, the operator defines the schedule for the promotional event. The schedule includes at least two components. One component is the time period that advertising content for the promotional event will be displayed. The other component is the actual time period during which the promotional event will be active. In some embodiments these two time periods can be identical thus eliminating the need to program two time periods. At step 920, the operator defines the winning criteria. In the embodiment illustrated in FIG. 7, this step includes selecting the cards to be included in the winning hand. However, this step can vary greatly depending on the embodiment of the invention. For instance, in a restaurant setting, this step may include identifying a menu item. At step 925, the operator defines the promotional content to be displayed for advertising the promotional event. This step could involve importing a graphic or text file from another source or actually defining the art work. At step 930, the information pertaining to the promotional event is provided to the controller box 150.

It should be appreciated that multiple promotional events can be scheduled and loaded into the controller box 150. In fact, multiple promotional events can be concurrently active. The controller box can receive a download of all scheduled promotional events and at step 935, the controller box displays the advertising content pertaining to the promotional events in accordance with the schedule associated with the promotional events. Alternatively, the promotional server may only download information to the controller box when the information is active. At step 940, the controller box monitors the activity of the gaming machine in accordance with the schedule associated with the active time period for the promotional event. At step 945, the controller box 150 identifies that the criteria for a winning event has been satisfied. At step 950, the controller box 150 creates a record regarding the winning event. Depending on the particular embodiment, the content in this record can vary greatly. Typical embodiments will include information such as, but not limited to, the identity of the gaming machine, the identity of the player, the time and date of the winning event, the winning event, the identification of the promotional event, the address of the gaming machine, the location of the gaming machine, etc. In some embodiments, the controller may include a GPS signal receiver that can be used to identify the location of the gaming machine. At step 955, the record is delivered to the promotional server 25.

It should be appreciated that the present invention also enables the reporting of other activity that is not necessarily associated with a comp or a promotional event. For instance, the operator may want to establish a maintenance schedule for the equipment based on particular criteria. The present invention can be used to define such criteria and monitor for the satisfaction of the criteria. For instance, such criteria could include events such as hours of usage, number of key presses, number of key presses for particular keys, detection of operating errors, detection of loss of power, or the like.

The present invention could also be used to identify the amount of financial exposure an operator has with his currently running promotions. For instance, if a budget has been set for the promotion, the system can monitor the payouts that have been awarded during the promotional event and, based upon this information the operator or the system can make decisions to limit or expand the duration or winning criteria of the promotion. Likewise, the operator can allocate additional bonus points to the budget, or further limit the budget of a promotional event based on the operator's historical business performance with the promotion.

From the information obtained through the use of various embodiments of the present invention, the success or failures of certain comps and promotions can be analyzed. This analysis can be used to identify particular attributes that may have contributed to the success or failure of the comp or promotion. For instance, the duration of the comp, the time of day the comp was run, the date of the comp, the amount of awards available for the comp and the winning criteria of the comp are several attributes that can be monitored and tracked to determine what effect, if any, these attributes have on driving the behavior of the players. As an example, an operator may determine that a particular comp that runs in the morning may be more likely to generate playing time from players than is generated when the comp is run in the evening.

The promotional server 25 stores received records at step 960 and maintains a database of records received from the controller box 150. It should be appreciated that the promotional server 25 can support many controller boxes 150 for many different operators. Thus, the promotional server 25 includes a security mechanism to restrict access to records and files. Such security mechanism may be password protection, or may include more advanced security techniques that should be familiar to those skilled in the art.

Operation in Other Settings

Although the present invention has been described with particular reference to a gaming or gambling scenario, the present invention, or aspects of the present invention, may be equally applied in a variety of other settings. For instance, in a restaurant setting, aspects of the present invention can be used to display special events within the restaurant. Thus, if a restaurant owner wants to promote a particular item on the menu, the restaurant owner may program a promotional event to be displayed on monitors within the restaurant. One example of such an event may be that a 20% discount is available to any patrons ordering the chicken fried steak during a particular period of time or day. In the typical restaurant setting, this embodiment is dependent upon accurate reporting by the waiter or waitress, however, in this embodiment; the integrity afforded by the closed-loop system is not as important as in the gambling scenario.

The present invention can also be used for performing management or controlling functions in various environments. For instance, in the restaurant setting again, various criteria can be entered as the basis of “winning events” where the winning events define particular management or control events. For instance, winning events may be defined to monitor inventory levels. In this scenario, if the inventory of a particular item drops below a particular threshold, it may trigger a reorder message. As another example, if the inventory for a perishable item is in stock beyond a certain date or time period, a message can be triggered to identify that item as being expired. As yet another example, the winning event may identify a particular product and the ingredients of that product. In this scenario, a message can be triggered based on the duration that the product should exist on the shelf or be available to patrons prior to the expiration. In addition, a message may be triggered to indicate that the inventory of ingredients to create this product has decreased beyond a particular threshold. Other criteria that can be included in this scenario could be the historical pattern of the pace of selling this product. In each of these scenarios, the generated messages can be displayed on a monitor or sent to a communication device to notify the responsible parties.

The present invention could also be incorporated into a bowling alley scenario. In this embodiment, the controller box 150 interfaces to the scoring control mechanism for the bowling alley. On the individual scoring screens, various promotional events can be displayed, such as, hitting a strike between the hours of 3 pm to 4 pm will award a free game to the bowler.

The present invention has been described using detailed descriptions of embodiments thereof that are provided by way of example and are not intended to limit the scope of the invention. It will be appreciated that other uses of the present invention are also anticipated. The described embodiments comprise different features, not all of which are required in all embodiments of the invention. Some embodiments of the present invention utilize only some of the features or possible combinations of the features. For instance, the controller box 150 has been described as interfacing to the processor and display of a particular machine. In some embodiments, the display and the processor may be totally independent. An example of such a scenario would be in a setting that the display includes a television or video monitor and the controller box 150 monitors activity of an independent device such as a juke box, trivia machine, point-of-sale terminal or arcade machine. Variations of embodiments of the present invention that are described and embodiments of the present invention comprising different combinations of features noted in the described embodiments will occur to persons of skilled in the art. The scope of the invention is limited only by the following claims.

While the invention has been described in terms of various specific embodiments, those skilled in the art will recognize that the invention can be practiced with modification within the spirit and scope of the claims.

What is claimed is:

1. A system for interacting with players of video gaming machines, the system comprising:
at least one video gaming machine;
a database for storing player information and player interaction rules for a plurality of players, the player information including data representing historical gaming activity of each player and data describing each player, the player interaction rules defining interactions between the gaming operator and each player; and
a server coupled to the at least one video gaming machine and the database, the server programmed to:
monitor the at least one video gaming machine including identifying a player utilizing the at least one video gaming machine and recording activities of the identified player on the at least one video gaming machine;
determine whether a player interaction rule is satisfied based on the identification of the player and the recorded activities of the identified player; and
display an award offer on the at least one video gaming machine for inducing the identified player to continue playing when a player interaction rule is satisfied.

2. A system in accordance with claim 1 wherein one of the player interaction rules is programmed to:
determine an average time the identified player utilizes a typical video gaming machine during a session;
compare the average time with a monitored time the identified player has utilized a current video gaming machine during a session; and
display the award offer prior to the monitored time equaling the average time.

3. A system in accordance with claim 1 wherein each of the player interaction rules is determined by at least one gaming machine condition, at least one gaming session condition, at least one ad-hoc condition, at least one unregistered player condition and at least one clustered gaming condition.

4. A system in accordance with claim 1 wherein the historical playing activity of each player includes an amount of money wagered, an amount of money won, an amount of money lost and an amount of time the identified player spent at the at least one video gaming machine.

5. A system in accordance with claim 1 wherein the at least one video gaming machine includes a main video display having touch screen capability and at least one button, the main video display and at least one button being used for receiving interaction from the identified player.

6. A system in accordance with claim 1 wherein each of the player interaction rules allows a different interaction between the gaming operator and the identified player when a correspondingly different condition is satisfied.

7. A system in accordance with claim 1 wherein when the identified player accepts the award offer a voucher is printed and when the identified player refuses the comp offer play continues.

8. A method for interacting with players of video gaming machines using a computer coupled to a database and the video gaming machines, the method comprising:
storing within the database player information and player interaction rules for a plurality of players, the player information including data representing historical gaming activity of each player and data describing each player, the player interaction rules defining interactions with each player;
monitoring at least one video gaming machine using the computer;
identifying a player utilizing the at least one video gaming machine based on the player information stored within the database and recording activities of the identified player on the at least one video gaming machine;
determining whether a player interaction rule is satisfied based on the identification of the player and the recorded activities of the identified player, wherein the determination is made using the computer; and
displaying an award offer on the at least one video gaming machine for inducing the identified player to continue playing when a player interaction rule is satisfied.

9. A method in accordance with claim 8 further comprising:
programming one of the player interaction rules to determine an average time the identified player utilizes the at least one video gaming machine during a session, compare the average time with a monitored time the identified player utilizes the video gaming machine during a session, and display the award offer prior to the monitored time equaling the average time.

10. A method in accordance with claim 8 further comprising programming each of the player interaction rules using at least one gaming machine condition, at least one gaming session condition, at least one ad-hoc condition, at least one unregistered player condition and at least one clustered gaming condition.

11. A method in accordance with claim 8 wherein the historical gaming activity of each player includes an amount of money wagered, an amount of money won, an amount of money lost and an amount of time the identified player spent at the at least one video gaming machine.

12. A method in accordance with claim 8 further comprising receiving interaction from the identified player using a touch screen capable video gaming machine display and at least one video gaming machine button.

13. A method in accordance with claim 8 further comprising generating a different interaction between the gaming operator and the identified player from the player interaction rules when a correspondingly different condition is satisfied.

14. A method in accordance with claim 8 further comprising the identified player accepting the award offer and receiving a printed voucher, or the identified player refusing the award offer and continuing play.

15. A computer program embodied on a computer readable medium for enabling an operator of video gaming machines to interact with players of the video gaming machines, the computer program being comprised of instructions, which when read and executed by a computer, cause the computer to perform the following steps:
store player information and player interaction rules for a plurality of players within a database, the player information including data representing historical gaming activity of each player and data describing each player, the player interaction rules defining interactions between the gaming operator and each player;
monitor at least one video gaming machine;
identify a player utilizing the at least one video gaming machine based on the player information stored within the database and record activities of the identified player on the at least one video gaming machine;
determine whether a player interaction rule is satisfied based on the identification of the player and the recorded activities of the identified player; and
display an award offer on the at least one video gaming machine for inducing the identified player to continue playing when a player interaction rule is satisfied.

16. A computer program in accordance with claim 15 further comprising instructions, which when read and executed by a computer, cause the computer to:
program one of the player interaction rules to be based on an average time the identified player utilizes the at least one video gaming machine;
compare the average time with a monitored time the identified player utilizes the video gaming machine; and
display the award offer prior to the monitored time equaling the average time.

17. A computer program in accordance with claim 15 further comprising instructions, which when read and executed by a computer, cause the computer to determine each of the player interaction rules using at least one gaming machine condition, at least one gaming session condition, at least one ad-hoc condition, at least one unregistered player condition and at least one clustered gaming condition.

18. A computer program in accordance with claim 15 wherein the historical gaming activity of each player includes an amount of money wagered, an amount of money won, an amount of money lost and an amount of time the identified player spent at the at least one video gaming machine.

19. A computer program in accordance with claim 15 further comprising instructions, which when read and executed by a computer, cause the computer to receive interaction from the identified player using a touch screen capable video gaming machine display and at least one video gaming machine button.

20. A computer program in accordance with claim 15 further comprising instructions, which when read and executed by a computer, cause the computer to generate a different interaction between the operator and the identified player from the player interaction rules when a correspondingly different condition is satisfied.

21. A computer program in accordance with claim 15 further comprising instructions, which when read and executed by a computer, cause the computer to enable the identified player to accept the award offer and receive a printed voucher or enable the identified player to refuse the award offer and continuing play.

22. A computer for an operator of video gaming machines to interact with players of the video gaming machines, the computer comprising:
a processor; and
a database for storing player information and player interaction rules for a plurality of players, the player information including data representing historical gaming activity of each player and data describing each player, the player interaction rules defining interactions between the gaming operator and each player; and
the computer coupled to at least one video gaming machine, wherein the computer is programmed to:
monitor the at least one video gaming machine including identifying a player utilizing the at least one video gaming machine and recording activities of the identified player on the at least one video gaming machine;
determine whether a player interaction rule is satisfied based on the identification of the player and the recorded activities of the identified player; and
display an award offer on the at least one video gaming machine for inducing the identified player to continue playing when a player interaction rule is satisfied.

23. A computer in accordance with claim 22 wherein one of the player interaction rules is programmed to:
determine an average time the identified player utilizes the at least one video gaming machine during a session;
compare the average time with a monitored time the identified player utilizes the video gaming machine during a session; and
display the award offer prior to the monitored time equaling the average time.

24. A computer in accordance with claim 22 wherein each of the player interaction rules is determined by at least one gaming machine condition, at least one gaming session condition, at least one ad-hoc condition, at least one unregistered player condition and at least one clustered gaming condition.

25. A computer in accordance with claim 22 wherein the historical gaming activity of each player includes an amount of money wagered, an amount of money won, an amount of money lost and an amount of time the identified player spent at the at least one video gaming machine.

26. A computer program in accordance with claim 22 wherein the at least one video gaming machine includes a main video display having touch screen capability and at least one button, the main video game machine display and the at least one button being used for receiving interaction from the identified player.

27. A computer program in accordance with claim 22 wherein each of the player interaction rules allows a different interaction between the gaming operator and the identified player when a correspondingly different condition is satisfied.

28. A computer program in accordance with claim 22 wherein when the identified player accepts the award offer a voucher is printed and when the identified player refuses the award offer play continues.
